(19) United States
(12) Patent Application Publication
(10) Pub. No.: US 2005/0262157 A1
(43) Pub. Date: Nov. 24, 2005

(54) Interface cool ice OLEDB consumer interface

(76) Inventors: Tadd E. Vanyo, New Brighton, MN (US); Craig D. Hanson, St. Paul, MN (US); Neil A. Lambert, Ham Lake, MN (US); Michael F. Parenteau, Roseville, MN (US)

Correspondence Address: UNISYS CORPORATION;MS 4773, PO BOX 64942, ST. PAUL, MN, 55164-0942, US

(21) Appl. No.: 10/849,473

(22) Filed: May 19, 2004

(51) Int. Cl. G06F 7/00

(52) U.S. Cl. 707/200

(57) ABSTRACT

An apparatus for and method of utilizing an Internet terminal coupled to the world wide web to access data from a legacy data base via a legacy data base management system wherein said legacy data base and said legacy data base management system are incompatible. The user request is passed to the legacy data base management system via the Internet. The user request is converted into a form which can log-on and log-off from the legacy data base. Other commands when converted can fetch data, modify data, and store data from the legacy data base. Using these commands, data can be copied from the legacy data base into the legacy data base management system, from which it can be operated upon using all of the tools of the legacy data base management system. Following modification, the data can be recopied back into the legacy data base.

### CROSS REFERENCE TO CO-PENDING APPLICATIONS

U.S. patent application Ser. No. ______, filed ______, and entitled, “Cool ICE data Wizard”; U.S. patent application Ser. No. ______, filed ______, and entitled, “Cool ICE Column Profiling”; U.S. patent application Ser. No. ______, filed ______, and entitled, “Stored Procedure”; and U.S. patent application Ser. No. ______, filed ______, and entitled, “Cool ICE State Management” are commonly assigned co-pending applications incorporated herein by reference.

### BACKGROUND OF THE INVENTION

1. Field of the Invention:

The present invention generally relates to data base management systems and more particularly relates to enhancements for providing access to specific data base types via legacy data base management systems from Internet user terminals.

2. Description of the prior art:

Data base management systems are well known in the data processing art. Such commercial systems have been in general use for more than 20 years. One of the most successful data base management systems is available from Unisys Corporation and is called the Classic MAPPER® data base management system. The Classic MAPPER system can be reviewed using the Classic MAPPER User's Guide which may be obtained from Unisys Corporation.

The Classic MAPPER system, which runs on proprietary hardware also available from Unisys Corporation, provides a way for clients to partition data bases into structures called filing cabinets and drawers, as a way to offer a more tangible format. The Mapper data base manager utilizes various predefined high-level instructions whereby the data base user may manipulate the data base to generate human-readable data presentations called “reports”. The user is permitted to prepare lists of the various predefined high-level instructions into data base manager programs called “Mapper Script”. Thus, users of the Classic MAPPER system may create, modify, and add to a given data base and also generate periodic and aperiodic reports using various Mapper Script.

However, with the Classic MAPPER system, as well as with similar proprietary data base management systems, the user must interface with the data base using a terminal coupled directly to the proprietary system and must access and manipulate the data using the Mapper Script command language of Classic MAPPER. Ordinarily, that means that the user must either be co-located with the hardware which hosts the data base management system or must be coupled to that hardware through dedicated telephone, satellite, or other data links. Furthermore, the user usually needs to be schooled in the command language of Classic MAPPER (or other proprietary data base management system) to be capable of generating Mapper Script.

Since the advent of large scale, dedicated, proprietary data base management systems, the Internet or world wide web has come into being. Unlike closed proprietary data base management systems, the Internet has become a world wide bulletin board, permitting all to achieve nearly equal access using a wide variety of hardware, software, and communication protocols. Even though some standardization has developed, one of the important characteristics of the world wide web is its ability to constantly accept new and emerging techniques within a global framework. Many current users of the Internet have utilized several generations of hardware and software from a wide variety of suppliers from all over the world. It is not uncommon for current day young children to have ready access to the world wide web and to have substantial experience in data access using the Internet.

Thus, the major advantage of the Internet is its universality. Nearly anyone, anywhere can become a user. That means that virtually all persons are potentially Internet users without the need for specialized training and/or proprietary hardware and software. One can readily see that providing access to a proprietary data base management system, such as Classic MAPPER, through the Internet would yield an extremely inexpensive and universally available means for accessing the data which it contains and such access would be without the need for considerable specialized training.

There are two basic problems with permitting Internet access to a proprietary data base. The first is a matter of security. Because the Internet is basically a means to publish information, great care must be taken to avoid intentional or inadvertent access to certain data by unauthorized Internet users. In practice this is substantially complicated by the need to provide various levels of authorization to Internet users to take full advantage of the technique. For example, one might have a first level involving no special security features available to any Internet user. A second level might be for specific customers, whereas a third level might be authorized only for employees. One or more fourth levels of security might be available for officers or others having specialized data access needs.

Existing data base managers have security systems, of course. However, because of the physical security with a proprietary system, a certain degree of security is inherent in the limited access. On the other band, access via the Internet is virtually unlimited which makes the security issue much more acute.

Current day security systems involving the world wide web involve the presentation of a user-id. Typically, this user-id either provides access or denies access in a binary fashion. To offer multiple levels of secure access using these techniques would be extraordinarily expensive and require the duplication of entire databases and or substantial portions thereof. In general, the advantages of utilizing the world wide web in this fashion to access a proprietary data base are directly dependent upon the accuracy and precision of the security system involved.

The second major problem is imposed by the Internet protocol itself. One of the characteristics of the Internet which makes it so universal is that any single transaction in HTML (hypertext markup language) combines a single transfer (or request) from a user coupled with a single response from the Internet server. In general, there is no means for linking multiple transfers (or requests) and multiple responses. In this manner, the Internet utilizes a transaction model which may be referred to as “stateless”. This limitation ensures that the Internet, its users, and its servers remain sufficiently independent during operation that no one entity or group of entities can unduly delay or “hang-up” the communications system or any of its major components. Each transmission results in a termination of the transaction. Thus, there is no general purpose means to link data from one Internet transaction to another, even though in certain specialized applications limited amounts of data may be coupled using “cookies” or via attaching data to a specific HTML screen.

However, some of the most powerful data base management functions or services of necessity rely on coupling data from one transaction to another in dialog fashion. In fact this linking is of the essence of BIS (Unisys Business Information System) Scripts which assume change of state from one command language statement to the next. True statelessness from a first BIS command to the next or subsequent BIS command would preclude much of the power of Classic MAPPER (or any other modern data base management system) as a data base management tool and would eliminate data base management as we now know it.

Further problems arise with legacy data base management system access to various incompatible data bases. To be most useful, there must be the capability to access such preexisting, incompatible data bases.

### SUMMARY OF THE INVENTION

The present invention overcomes the disadvantages of the prior art by providing a method of and apparatus for utilizing the power of a full featured data base management system by a user at a terminal coupled to the world wide web or Internet to log-on, insert, update, delete, fetch, and log-off from a previously incompatible data base interface. Once the data has been copied from the existing data base into the BIS compatible data base, it can be operated upon using all of the tools of the full featured BIS management system. In order to permit any such access, the present invention must first provide a user interface to the OLE DB data base. The interface converts the OLE DB response into a format readable by BIS and BIS users. Thus, as a minimum, the interface must make format and protocol conversions. In the preferred embodiment, the interface resides in the web server coupled to the user via the world wide web and coupled to the OLE DB data base management system.

To make access to an OLE DB legacy data base by Internet users practical, a sophisticated security system is required to prevent intentional or inadvertent unauthorized access to the sensitive data of an organization. As discussed above, such a security system should provide multiple levels of access to accommodate a variety of authorized user categories. In the preferred embodiment of the present invention, rather than defining several levels of data classification, the different classes of users are managed by identifying a security profile as a portion of those service requests requiring access to secure data. Thus, the security profile accompanies the data/service to be accessed. The user simply need provide a user-id which correlates to the access permitted. This permits certain levels of data to be accessed by one or more of the several classes of user.

In the preferred mode of practicing the present invention, each user-id is correlated with a security profile. Upon preparation of the service request which provides Internet access to a given portion of the data base, the service request developer specifies which security profiles are permitted access to the data or a portion thereof. The service request developer can subsequently modify the accessibility of any security profile. The utility of the system is greatly enhanced by permitting the service request developer to provide access to predefined portions of the data, rather than being limited to permitting or denying access to all of the data involved.

Whereas the interface and the security system are the minimum necessary to permit the most rudimentary form of communication between the Internet terminal of the user and the proprietary data base management system, as explained above, the Internet is a “stateless” communication system; the addition of the interface and the security system do not change this statelessness. To unleash the real power of the data base management system, the communication protocol between the data base and the user requires functional interaction between the various data transfers.

The present invention adds state management to this environment. Instead of considering each transfer from the Internet user coupled with the corresponding server response as an isolated transaction event as defined by the world wide web, one or more related service requests may be functionally associated in a service request sequence as defined by the data base management system into a dialog.

A repository is established to store the state of the service request sequence. As such, the repository can store intermediate requests and responses, as well as other data associated with the service request sequence. Thus, the repository buffers commands, data, and intermediate products utilized in formatting subsequent data base management service requests and in formatting subsequent HTML pages to be displayed to the user.

The transaction data in HTML format received by the server from the user, along with the state information stored in the repository, are processed by a service handler into a sequence of service requests in the command language of the data base management system. Sequencing and control of the data base management system is via an administration module.

Through the use of the repository to store the state of the service request sequence, the service handler to generate data base management command language, and the administration module, the world wide web user is capable of performing each and every data base management function available to any user, including a user from a proprietary terminal having a dedicated communication link which is co-located with the proprietary data base management system hardware and software. In addition, the data base management system user at the world wide web terminal is able to accomplish this in the HTML protocol, without extensive training concerning the command language of the data base management system.

In accordance with the preferred embodiment of the present invention, a user is permitted to easily operate on data within an existing data base which is otherwise incompatible with the preferred legacy data base management system, BIS. This is accomplished by providing the user with the ability to Log-on, Insert, Update, Delete, Fetch, and Log-Off an OLEDB data base. Using these commands, the user can copy OLEDB data into a BIS report. Once in the report format, the user can operate upon the OLEDB data utilizing all of the tools of the BIS data base management system. The modified data can then be similarly copied form the BIS report back into the OLEDB data base. This technique relieves the user from the necessity of coding a C language program to operate upon the OLEDB data.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a pictographic view of the hardware of the preferred embodiment;

FIG. 2 is a pictorial diagram of the basic command process flow;

FIG. 3, including FIGS. 3A and 3B, is functional flow diagram for the basic command;

FIG. 4 is a schematic diagram showing the BIS and MRIM components;

FIG. 5 is a detailed flow chart showing the operation of the OLEDB Log-On command;

FIG. 6 is a detailed flow chart showing the operation of the OLEDB insert, update, delete, fetch commands; and

FIG. 7 is a detailed flow chart showing the operation of the OLEDB Log-Off command.

### DETAILED DESCRIPTION OF THE PREFERRED EMBODIMENTS

The present invention is described in accordance with several preferred embodiments which are to be viewed as illustrative without being limiting. These several preferred embodiments are based upon Series 2200 hardware and operating systems, the Classic MAPPER data base management system, and the BIS/Cool ICE software components, all available from Unisys Corporation. When used herein, OLEDB refers to a COM-based Application Programming Interface (API) designed to provide access to a wide range of data sources. OLEDB includes SQL functionality but also defines interfaces suitable for gaining access to data other than SQL data. COM facilitates application integration by defining a set of standard interfaces. Each interface contains a set of functions that define a contract between the object implementing the interface and the client using it. A UDL file contains the complete connection string information, including the data source, userid, password, and any other information needed to logon to and fetch data.

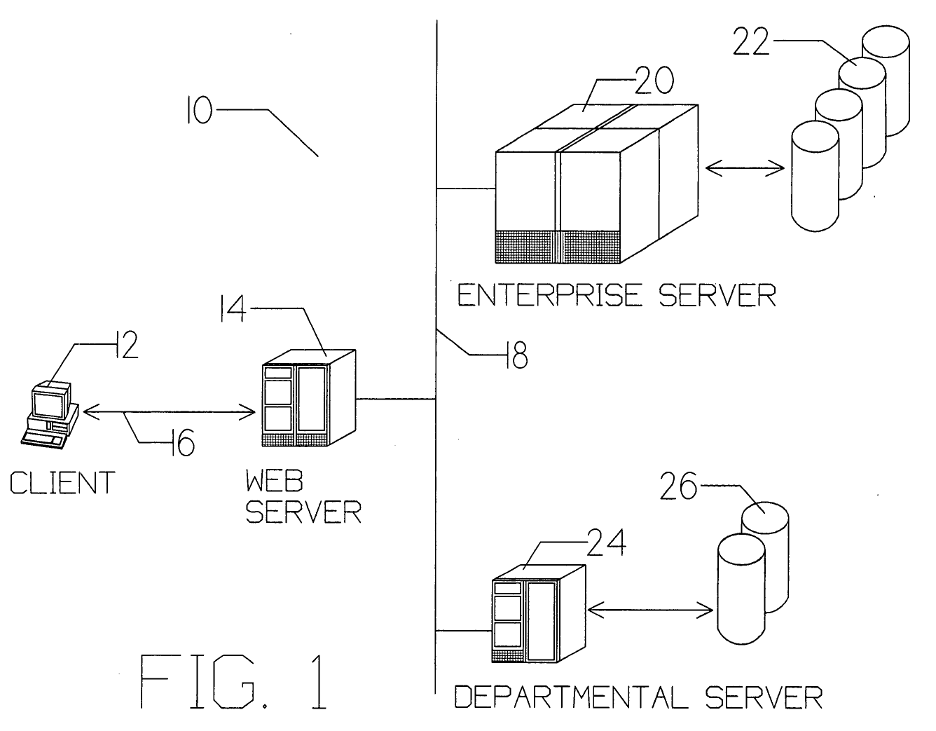

FIG. 1 is a pictorial diagram of hardware suite 10 of the preferred embodiment of the present invention. The client interfaces with the system via Internet terminal 12. Preferably, Internet terminal 12 is an industry compatible, personalized computer having a current version of the Windows operating system and suitable web browser, all being readily available commercial products. Internet terminal 12 communicates over world wide web access 16 using standardized HTML protocol, via Web Server 14.

The BIS/Cool ICE system is resident in Enterprise Server 20 and accompanying storage subsystem 22, which is coupled to Web Server 14 via WAN (Wide Area Network) 18. In the preferred mode, Web Server 14 is owned and operated by the enterprise owning and controlling the proprietary legacy data base management system. Web Server 14 functions as the Internet access provider for Internet terminal 12 wherein world wide web access 16 is typically a dial-up telephone line. This would ordinarily be the case if the shown client were an employee of the enterprise. On the other hand, web server 14 may be a remote server site on the Internet if the shown client has a different Internet access provider. This would ordinarily occur if the shown client were a customer or guest.

In addition to being coupled to WAN 18, Enterprise Server 20, containing the BIS/Cool ICE system, is coupled to departmental server 24 having departmental server storage facility 26. Additional departmental servers (not shown) may be similarly coupled. The enterprise data and enterprise data base management service functionality typically resides within enterprise server 20, departmental server 24, and any other departmental servers (not shown). Normal operation in accordance with the prior art would provide access to this data and data base management functionality for users coupled to WAN 12.

In the preferred mode of the present invention, access to this data and data base management functionality is also provided to users (e.g., Internet terminal 12) coupled to World Wide Access 16. As explained below in more detail, web server 14 provides this access utilizing the BIS/Cool ICE system.

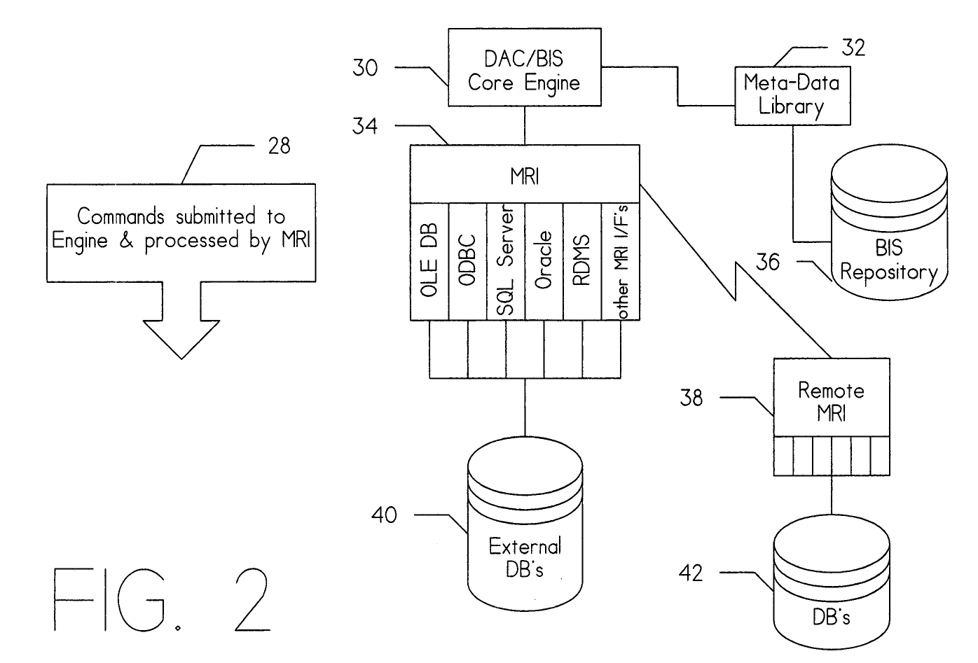

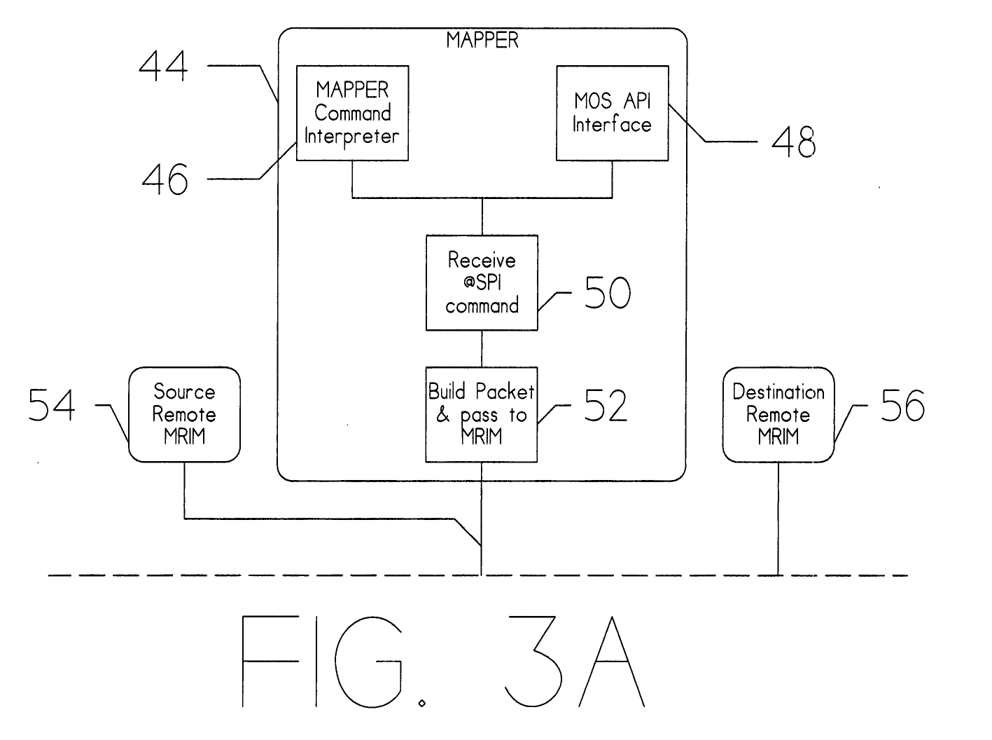

FIG. 2 is a functional diagram showing the major components of the @SPI (stored procedure interface) command process flow. This command is a part of the MRI (BIS Relational Interface) set of commands and combines many of the attributes of the previously existing @FCH (relational aggregate fetch) and @SQL (standard query language) commands. However, it is specifically targeted to executing stored procedures.

Command set 28 represents the commands defined for processing by MRI. In addition to @SPI, @FCH, and @SQL, @LGN (log on), MRI recognizes @LGF (log off), @DDI (data definition information), @RAM (relational aggregate modify), @TRC (trace relational syntax), @MQL (submit SQL syntax to a BIS data base) as the remaining commands. DAC/BIS core Engine 30 provides the basic logic for decode and execution of these commands. MRI 34 has relational access to data in the external databases 40 via the listed data base management formats. In addition, MRI 34 can call upon remote MRI 38 to make similar relational access of remote data bases 42.

DAC/BIS core engine 30 executes commands utilizing meta-data library 32 and BIS repository 36. Meta-data library 32 contains information about the data within the data base(s). BIS repository 36 is utilized to store command language script and state information for use during command execution.

The @SPI command has the following basic format:

@SPI, c, d, lab, db, edsp?, action, wrap, vert ‘sp-syntax’, vpar1 . . . , vparN, typ1, . . . typN. Fields c and d refer to the cabinet and drawer, respectively, which hold the result. The lab field contains a label “go to” if the status in the vstat variable specifies other than normal completion. The required “db” field provides the data base name. The “edsp?” field specifies what is to be done with the result if an error occurs during execution.

The sub-field labeled “action” defines what action is to be performed. The options include execution, return of procedures lists, etc. The “wrap” sub-field indicates whether to truncate or wrap the results. The “vert” sub-field defines the format of the results. The name of the stored procedure is placed into the “[sp-syntax]” field. The “vpar1” through “vparN” fields provide for up to 78 variables that correspond to stored procedure parameters. Finally, the “typ1” through “typN” fields define the type of each stored procedure parameter.

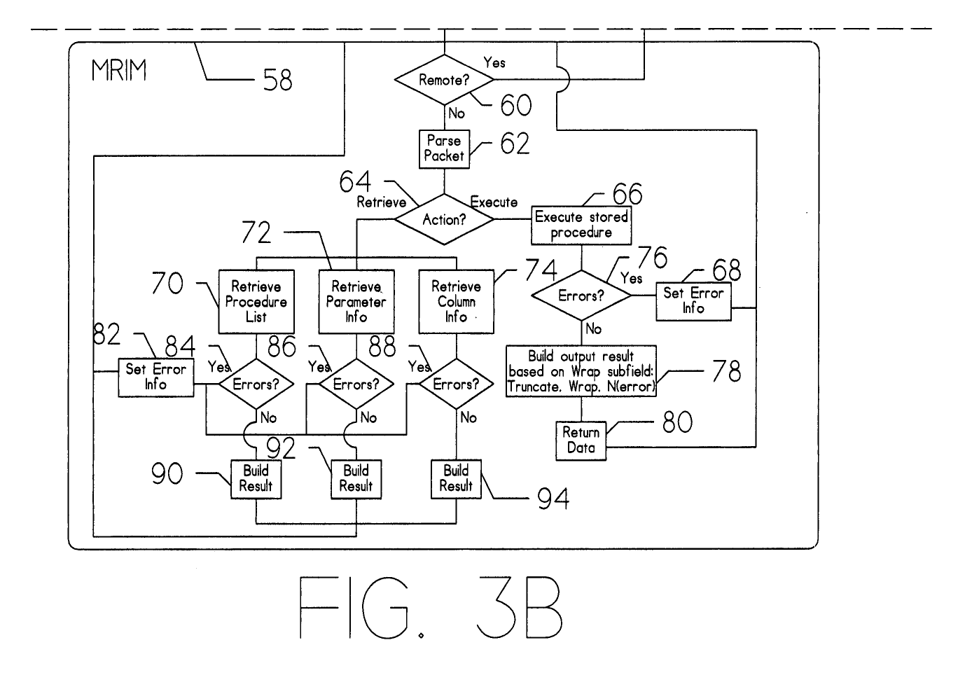

FIG. 3 is a high-level functional flow diagram for the command. The heart of the system is the BIS Relational Interface Module (MRIM) containing much of the logic for the preferred mode of the present invention. It is provided local data/commands from BIS 44 and remote data/commands from Source Remote MRIM 54. Remote results are forwarded via Destination Remote MRIM 56.

BIS 44 includes the BIS Command Interpreter 46 and MOS API Interface 48 which provide the @SPI command to Receiver 50. The packet is built by element 52 for transfer to MRIM 58.

MRIM 58 receives remote packets from Source Remote MRIM 54. The @SPI command packet is received by element 60, whether local or remote. Remote packets are forwarded via Destination Remote MRIM 56. Local packets are passed to element 62 for parsing. Control is given to element 64 for switching between retrieve commands and execute commands.

Request packets for retrieval are routed to element 70, 72, or 74 depending upon whether it requests a list, parameter information, or column information, respectively. Upon the appropriate retrieval, elements 84, 86, and 88 look for a retrieval error. If yes, control is given to element 82 for setting the error information before exit. If not, control is given to element 90, 92, or 94 for building of the result packet, before exit.

Element 64 routes execution request packets to element 66 for execution of the stored procedure. Element 76 determines whether an error has occurred. If yes, element 68 sets the error information before exit. If not, element 78 builds the output results packet. Element 80 returns the data before exit.

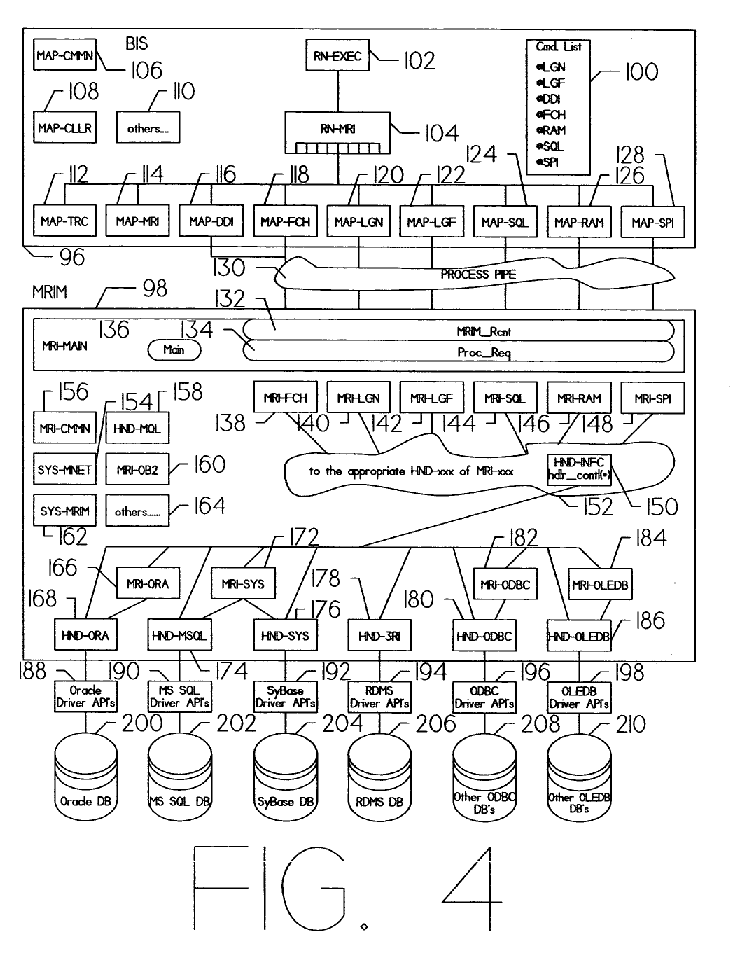

FIG. 4 is a detailed block diagram showing the major components of BIS and MRIM as utilized in accordance with the preferred mode of the present invention. BIS 96 receives command packets such as MAP-CMMN 106, MAP-CLLr 108, or others 110. Command List 100 specifies which of the commands are valid and to be executed. These are @LGN (log on), @LGF (log off), @DDI (data definition information), @FCH (relational aggregate fetch), @RAM (relational aggregate modify), @SQL (standard query language), and SPI (stored procedure interface). These commands are executed using RN-Exec 102, RN-MRI 104, and specialized elements 116, 118, 120, 122, 124, 126, and 128, whereas elements 112 and 114 handle @TRC (trace relational syntax) and information requests. Packets are prepared for all of the listed commands for transfer via interface 130 to MRIM 98.

Interface from BIS 96 to MRIM 98 is handled by MRI-Main 136. The incoming packets are routed via MRIM_Rcvr 132 and Proc_Req 134, as appropriate. Each of the listed commands (see list 100) is assigned to the corresponding one of the request handlers 138, 140, 142, 144, 146, and 148. After unpacking, switch 152, controlled by element 150, routes the information to the appropriate one(s) of the command handlers 166, 168, 170, 172, 174, 176, 178, 180, 182, 184, and 186. Data base command access is via the appropriate one(s) of the data base interfaces 188, 190, 192, 194, 196, and 198 to the specified one(s) of the available data bases 200, 202, 204, 206, 208, and 210. Internal utilities 154, 156, 158, 160, 162, and 164 assist in this process as needed.

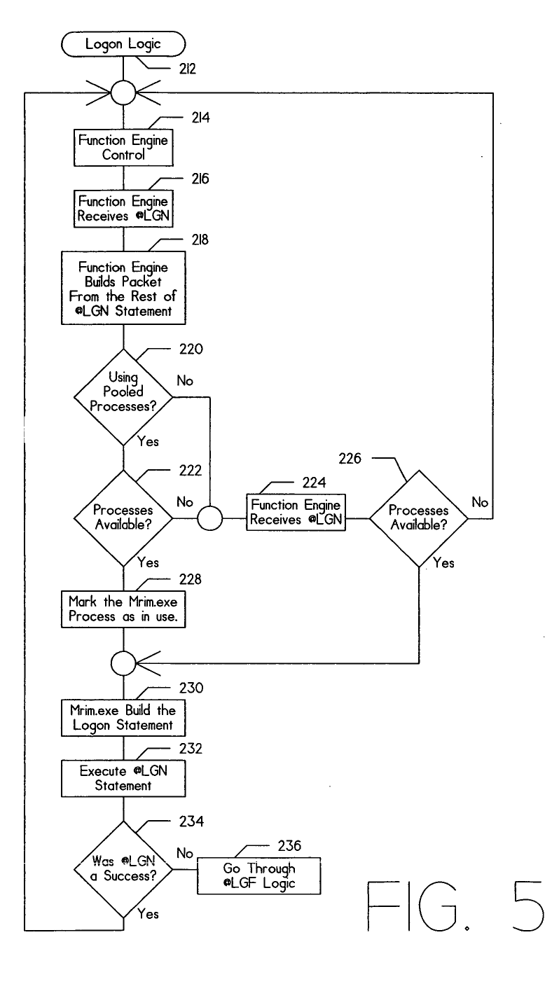

FIG. 5 is a detailed flow chart showing operation of the Log-On command. Entry is via element 212. At element 214, the function engine control begins analysis of the received command. The @LGN command is identified at element 216. The information from the @LGN command is utilized to build a command packet at element 218. Element 220 determines whether a pooled process is involved. If no, control is given to element 224. If yes, element 222 determines whether the required processes are available. If not control is given to element 224. If available, control is given to element 228.

The @LGN command is provided to the function engine at element 224. If element 226 determines that the needed processes are not available, control is returned to element 214, with no further possible processing of the current command. If the processes are now available, element 226 provides command to element 230.

The Mrim.exe process is marked in use by element 228. At element 230 Mrim.exe builds the actual Log-On statement. This statement is executed at element 232 to perform the log-on function. Element 234 determines whether the execution was successful. If yes, control is returned to element 214 to await the next command. Otherwise control is given to element 236 to go through the @LGN logic.

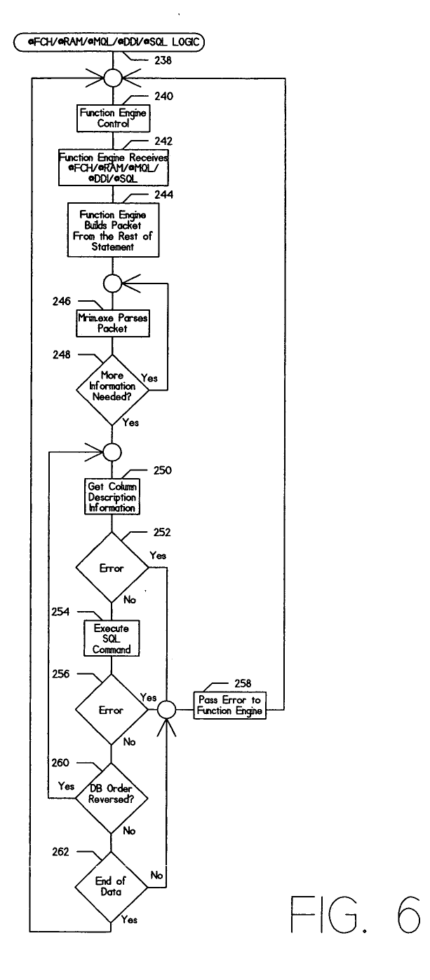

FIG. 6 is a detailed flow chart of operation of the commands which operate upon the OLEDB data. Entry is via element 238. The function engine control is initiated at element 240. The function engine receives the transferred command at element 242. The available commands are: @FCH (fetch); @RAM (relational aggregate modify); @DDI (data definition information); and @SQL (standard query language).

At element 244, the function engine builds a packet from the command statement. MRIM.exe parses the packet at element 246. Element 248 determines whether more information is needed. If yes, control is returned to element 246 for further parsing. If not, control is given to element 250 for obtaining the column information. Element 252 determines whether an error has occurred. If yes, control is given to element 258. If not, element 254 executes the SQL command. If element 256 determines that an error has occurred during the execution, control is given to element 258 for passing the error to the function engine, with control returned to element 240 for the next command.

If no error has occurred in the execution, element 260 determines if the data base order has been reversed. If yes, control is given to element 250 for re-execution of the command. If not, element 262 determines whether all data has been processed. If not, an error has occurred and control is given to element 258 for error processing. If no error, the command has been fully executed properly, and control is returned to element 240 for processing of the next command.

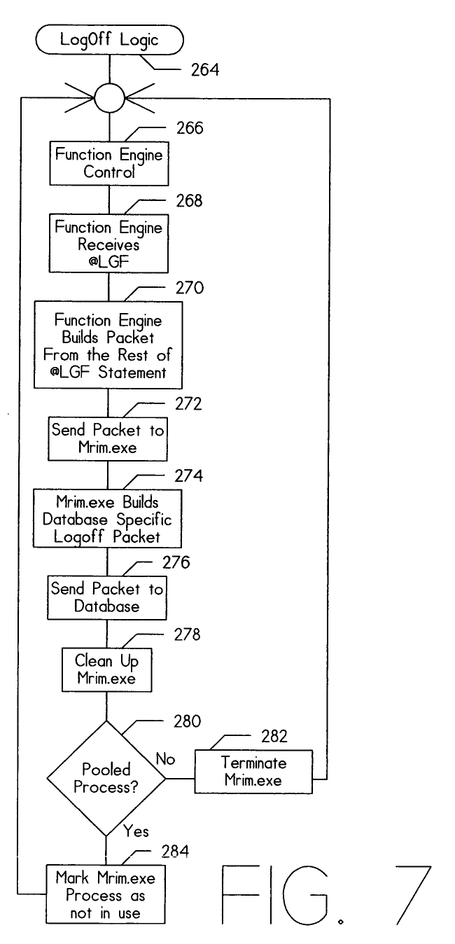

FIG. 7 is a detailed flow chart showing operation of the Log-Off command. Entry is via element 264. The function engine is initiated at element 266. The @LGF command is received at the function engine at element 268. The function engine builds a packet from the @LGF command at element 270.

The @LGF command packet is sent to Mrim.exe at element 272. Mrim.exe builds the data base specific log-off packet at element 274. Element 276 sends the packet to the appropriate data base. Mrim.exe is cleaned up at element 278.

Element 280 determines whether the command is a pooled process. If not, control is given to element 282 for termination of the process, and control is returned to element 266 for a future command. If it is a pooled process, element 280 gives control to element 284 to mark Mrim.exe as not in use. Control is returned to element 266 to await the next command.

Having thus described the preferred embodiments of the present invention, those of skill in the art will be readily able to adapt the teachings found herein to yet other embodiments within the scope of the claims hereto attached.

1. An apparatus comprising:
a. a user terminal which generates a first service request;
b. a publicly accessible digital data communication network responsively coupled to said user terminal;
c. a legacy data base management system responsively coupled to said user terminal via said publicly accessible digital data communication network which receives said first service request;
d. a legacy data base incompatible with, but responsively coupled to, said data base management system; and
e. a facility responsively coupled to said legacy data base management system and said legacy data base which permits said legacy data base management system to access said legacy data base in response to said receipt of said first service request.

2. The apparatus of claim 1 wherein said first service request causes said legacy data base management system to log on to said legacy data base.

3. The apparatus of claim 2 wherein said legacy data base further comprises an OLEDB data base.

4. The apparatus of claim 3 further comprising a second service request generated by said user terminal and transferred to said legacy data base management system which copies selected data from said legacy data base into said legacy data base management system.

5. The apparatus of claim 4 wherein said legacy data base management system further comprises a commercially available legacy data base management system.

6. A method of utilizing a user terminal to access selected data within a legacy data base comprising:
a. transmitting a first service request to a legacy data base management system which is incompatible with said legacy data base via a publicly accessible digital data communication network;
b. receiving said service request by said legacy data base management system;
c. converting said service request into a format cognizable by said legacy data base; and
d. transferring said converted service request from said legacy data base management system to said legacy data base.

7. A method according to claim 6 wherein said first service request further comprises a log-on command.

8. A method according to claim 7 wherein said publicly accessible digital data communication network further comprises the Internet.

9. A method according to claim 8 further comprising transferring a second service request from said user terminal to said legacy data base management system which causes a copying step after said transferring step which copies said selected data from said legacy data base to said legacy data base management system.

10. A method according to claim 9 wherein said legacy data base management system further comprises BIS data base management system.

11. An apparatus comprising:
a. permitting means for permitting a user to transfer a service request via a publicly accessible digital data communication network;
b. offering means responsively coupled to said permitting means via said publicly accessible digital data communication network for offering legacy data base management services using a scripted command language;
c. maintaining means responsively coupled, to but incompatible with, said offering means for maintaining a data base; and
e. converting means responsively coupled between said offering means and said maintaining means for converting said service request to a language cognizable by said maintaining means.

12. An apparatus according to claim 11 wherein said permitting means further comprises generating means for generating a second service request.

13. An apparatus according to claim 12 further comprising causing means located within said offering means for causing said maintaining means to copy data from said maintaining means into said offering means.

14. An apparatus according to claim 13 wherein said offering means further comprises BIS data base management system.

15. An apparatus according to claim 14 wherein said permitting means further comprises an industry standard personal computer.

16. In a data processing system having a user terminal which generates a first service request responsively coupled via a publicly accessible digital data communication network to a legacy data base management system, the improvement comprising:
a. a legacy data base incompatible with said legacy data base management system and responsively coupled thereto; and
b. a facility responsively coupled between said legacy data base management system and said legacy data base for converting said first service request to a form compatible with said legacy data base.

17. The improvement according to claim 16 wherein said converted service request further comprises a command to log on to said legacy data base.

18. The improvement according to claim 17 further comprising a second service request generated by said user terminal which causes said legacy data base management system to access first specified data within said legacy data base.

19. The improvement according to claim 18 further comprising a third service request generated by said user terminal which causes said legacy data base management system to modify second specified data within said legacy data base.

20. The improvement according to claim 19 further comprising a fourth service request generated by said user terminal which causes said legacy data base management system to log off from said legacy data base.

21. An apparatus comprising:
a. a user terminal which generates a first log-on service request, a second data-access service request, and a third log-off service request;
b. a publicly accessible digital data communication network responsively coupled to said user terminal;
c. a legacy data base management system responsively coupled to said user terminal via said publicly accessible digital data communication network which receives said first log-on service request, said second data-access service request, and said third log-off service request;
d. a legacy data base incompatible with, but responsively coupled to, said legacy data base management system; and
e. a facility responsively coupled to said legacy data base management system and said legacy data base which permits said legacy data base management system to log-on to said legacy data base in response said first log-on service request, access said legacy data base in response to said receipt of said second data-access service request, and log-off said legacy data base in response to receipt of said third log-off service request.
